(19) United States
(12) Patent Application Publication
(10) Pub. No.: US 2022/0397275 A1
(43) Pub. Date: Dec. 15, 2022

(54) PORTABLE COOKING SYSTEM

(71) Applicants: Jason C. HENSRUD, Kailua-Kona, HI (US); Bruk L. KOERTING, Kailua-Kona, HI (US)

(72) Inventors: Jason C. HENSRUD, Kailua-Kona, HI (US); Bruk L. KOERTING, Kailua-Kona, HI (US)

(21) Appl. No.: 17/832,653

(22) Filed: Jun. 5, 2022

Related U.S. Application Data
(60) Provisional application No. 63/208,939, filed on Jun. 9, 2021.

(51) Int. Cl. F24C 1/16; A47J 37/07

(52) U.S. Cl. CPC F24C 1/16; A47J 37/0763; A47J 37/0704; A47J 37/0786

(57) ABSTRACT

A self-contained portable cooking system that prevents mess and facilitates storage and transportation. In one embodiment, a portable cooking system includes an outer container defining a chamber; and a cooking unit being configured to be entirely contained within the chamber of the outer container, the cooking unit being removable from the outer container. In one embodiment, a method of using a portable cooking system includes removing the cooking unit from the outer container, placing an open second end of a cooking column of the cooking unit on a support surface, and placing a cooking platform of the cooking unit on an open first end of the cooking column.

### CROSS-REFERENCE TO RELATED APPLICATIONS

This application claims the benefit of U.S. Provisional Patent Application No. 63/208,939, filed Jun. 9, 2021, entitled PORTABLE COOKING SYSTEM, which is incorporated by reference herein in its entirety.

### GOVERNMENT RIGHTS STATEMENT

N/A.

### FIELD

This disclosure is related generally to a portable cooking system, and in particular, to a portable cooking system that includes an outer container sized and configured to contain all other components of the portable cooking system, thereby reducing mess and facilitating storage and transport.

### BACKGROUND

Portable cooking systems are needed to prepare food outside of the kitchen, such as when camping, at sporting events, or eating outdoors. Portable cooking systems are known, but these become greasy, dirty, and/or full of ashes, which makes transportation and storage difficult.

Some currently known systems, such as portable charcoal grills and portable propane gas grills, provide mobility and are sometimes small enough to be carried and/or transported in a vehicle. However, these systems are often unstable and include many parts and pieces that become dislodged, broken, or lost. Also, any expended fuel (such as ashes, charcoal chunks and residue), food bits, and grease easily fall out and can quickly stain and damage a vehicle interior, home carpeting, clothing, and any other surface in which they come into contact.

Finally, currently known systems do not provide an efficient way to organize and store system components as well as other needed items, such as condiments, utensils, fuel, food items, and the like. Such items are stored and transported separately, necessitating additional bags or carrying cases, and may easily become separated from the cooking system.

### SUMMARY

Some embodiments advantageously provide a self-contained portable cooking system that prevents mess and facilitates storage and transportation. In one embodiment, a portable cooking system includes: an outer container defining a chamber; and a cooking unit being configured to be entirely contained within the chamber of the outer container, the cooking unit being removable from the outer container.

In one aspect of the embodiment, the outer container includes a receptacle and a lid, the lid being removably couplable to the outer container.

In one aspect of the embodiment, the cooking unit includes: a cooking column; and a cooking platform, the cooking platform being removably engageable with the cooking column.

In one aspect of the embodiment, the cooking column has a longitudinal axis; and the cooking platform is at least substantially planar, the cooking platform lying in a plane that is at least substantially orthogonal to the longitudinal axis of the cooking column.

In one aspect of the embodiment, the cooking column has an at least substantially cylindrical shape with an open first end and an open second end opposite the open first end, the cooking platform being removably engageable with the open first end.

In one aspect of the embodiment, the cooking column includes a plurality of apertures proximate the open second end.

In one aspect of the embodiment, the open second end is configured to rest on a support surface when the cooking unit is in a use configuration.

In one aspect of the embodiment, the cooking unit further includes: a fuel tray; and a plurality of tabs extending from an inner surface of the cooking column, the plurality of tabs being configured to support the fuel tray within the cooking column and beneath the cooking platform when the cooking unit is in a use configuration.

In one aspect of the embodiment, the cooking unit further includes an ash tray, the ash tray being configured to be beneath the cooking platform and the fuel tray when the cooking unit is in the use configuration.

In one aspect of the embodiment, the fuel tray is at least substantially planar and includes a plurality of apertures.

In one aspect of the embodiment, the cooking unit further includes a basin/lid element, the basin/lid element being securely positionable on the cooking platform in a first use configuration and being securely positionable within the cooking column in a second use configuration.

In one aspect of the embodiment, the basin/lid element has a convex first orientation when in the first use configuration and a concave second orientation when in the second use configuration.

In one aspect of the embodiment, the cooking unit further includes a handle, each of the cooking column, the cooking platform, and the basin/lid element including at least one handle engagement element, and the handle being removably engageable with each of the at least one handle engagement element.

In one aspect of the embodiment, each of the at least one handle engagement element includes a first tubular element and a second tubular element; and the handle includes a first free end and a second free end, the first free end being configured to be inserted into the first tubular element and the second free end being configured to be inserted into the second tubular element.

In one aspect of the embodiment, the handle further includes a frame and an insert, the frame defining the first free end and the second free end, and the insert being configured to be retained within the frame.

In one aspect of the embodiment, the cooking unit includes a handle, the handle being removably engageable with at least a portion of the cooking unit.

In one embodiment, a portable cooking system includes: an outer container, the outer container defining a chamber; and a cooking unit, the cooking unit including: a cooking column, the cooking column having an open first end and an open second end; a cooking platform, the cooking platform being engageable with the open first end of the cooking column; a fuel tray, the fuel tray being configured to be suspended within the cooking column; and a basin/lid element, the basin/lid element being configured to rest on the cooking platform in a first use configuration of the cooking unit and being configured to be suspended within the cooking column in a second use configuration of the cooking unit, the cooking unit being external to the outer container in the first and second use configurations of the cooking unit; and the cooking unit being entirely contained within the chamber of the outer container in a storage configuration of the cooking unit.

In one aspect of the embodiment, the cooking unit further includes a handle, each of the cooking column, the cooking platform, and the basin/lid element including at least one handle engagement element, and the handle being removably engageable with each of the at least one handle engagement element.

In one embodiment, a method of using a portable cooking system, with the portable cooking system including an outer container and a cooking unit, includes: removing the cooking unit from the outer container, the cooking unit including: a cooking column, the cooking column having an open first end, an open second end opposite the open first end, and a chamber extending therebetween; and a cooking platform; placing the cooking column on a support surface such that the open second end of the cooking column is in contact with the support surface; and placing the cooking platform on the open first end of the cooking column.

In one aspect of the embodiment, the method further includes: removing the cooking platform from the cooking column; removing the cooking column from the support surface; placing the cooking column and the cooking platform into the outer container; and sealing the outer container.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 shows a partially exploded view of an exemplary embodiment of a portable cooking system, in accordance with the present disclosure;

FIG. 2 shows a fully exploded view of the portable cooking system of FIG. 1, in accordance with the present disclosure;

FIG. 3 shows a side view of a cooking platform, in accordance with the present disclosure;

FIG. 4 shows a perspective view of a handle engagement element, in accordance with the present disclosure;

FIG. 5 shows a perspective view of the portable cooking system of FIGS. 1 and 2 in a storage configuration, in accordance with the present disclosure;

FIG. 6 shows a cross-sectional view of the portable cooking system of FIG. 5, in accordance with the present disclosure;

FIG. 7 shows a perspective view of the portable cooking system in a use configuration, in accordance with the present disclosure;

FIG. 8 shows a cross-sectional view of the portable cooking system of FIG. 7 in the use configuration, in accordance with the present disclosure;

FIG. 9 shows a perspective view of the portable cooking system in an alternative use configuration, in accordance with the present disclosure; and

FIG. 10 shows a cross-sectional view of the portable cooking system of FIG. 9 in the alternative use configuration, in accordance with the present disclosure.

### DETAILED DESCRIPTION

Before describing in detail exemplary embodiments, it is noted that the embodiments reside primarily in combinations of apparatus components and steps related to a portable cooking system and methods of use thereof. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Referring now to the figures in which like reference designators are used for like elements, an exemplary portable cooking system 10 is shown.

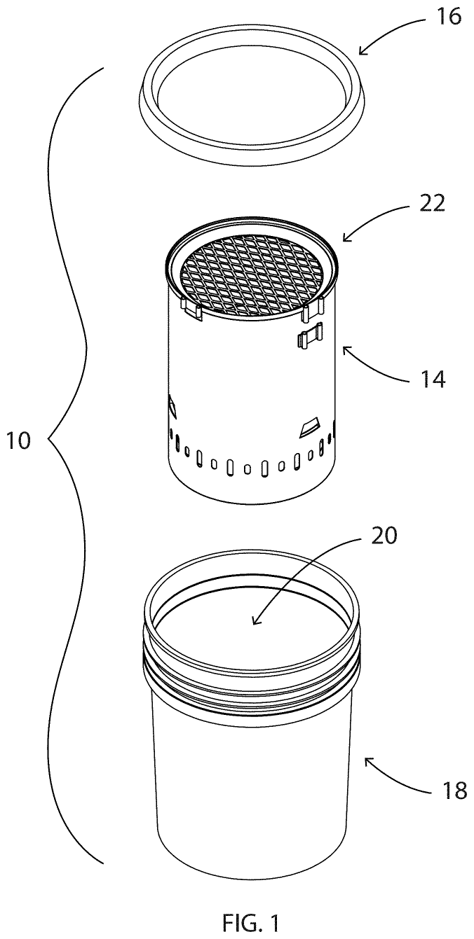

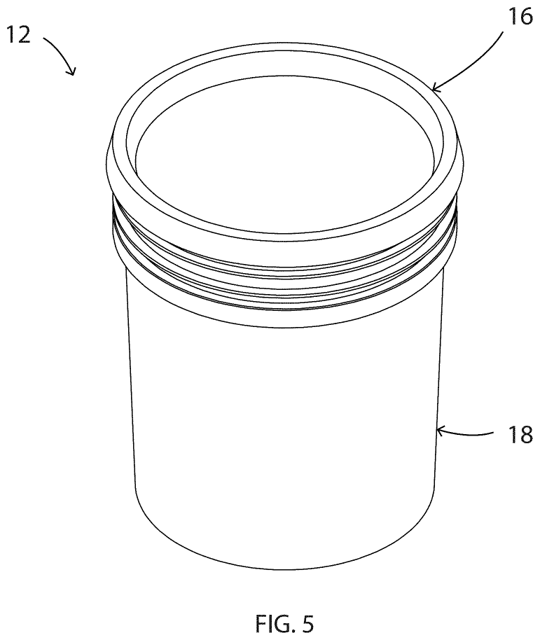

Referring now to FIG. 1, and with reference to FIG. 5, a partially exploded view of a portable cooking system 10 is shown. The portable cooking system 10 generally includes an outer container 12 (indicated in FIG. 5) and a cooking unit 14. In one embodiment, the outer container 12 generally includes a lid 16 and a receptacle 18 defining a chamber 20 therein. As is discussed in greater detail below, the cooking unit 14 is sized and configured to fit within the outer container 12 for storage and/or transport. In one embodiment, the lid 16 and receptacle 18 are composed of a lightweight and rigid or semi-rigid material such as plastic, metal, or wood. The lid 16 is removably attachable to the outer container 12 and, when attached, may form a fluid-tight seal to prevent the entry of moisture, dirt, spores, rodents, insects, and the like. In one non-limiting example, the outer container 12 is a five-gallon bucket, with or without a handle, and the lid 16 and receptacle 18 are composed of polyethylene or other plastic. In some embodiments, the outer container 12 is composed of a food-grade plastic. Further, in one embodiment the chamber 20 of the receptacle 18 is sized and configured to contain at least the cooking unit 14, and optionally other items as well (for example, grilling tongs, plates, napkins, condiments, utensils, and others). In some embodiments, the outer container 12 has a height of approximately 13.5 in. (±3.0 in.) and an inner diameter of approximately 11.0 in. (±2.0 in.).

Thus, during storage and/or transport, the lid 16 is coupled or couplable to the receptacle 18 securely enough to prevent the cooking unit 14 and/or any other components or items, including any food waste, ash, charcoal, or trash, from falling out of the outer container 12. Even if the outer container 12 topples over (for example, in the trunk, bed, or backset of a vehicle), the coupling between the lid 16 and receptacle 18 retains any mess within the outer container 12.

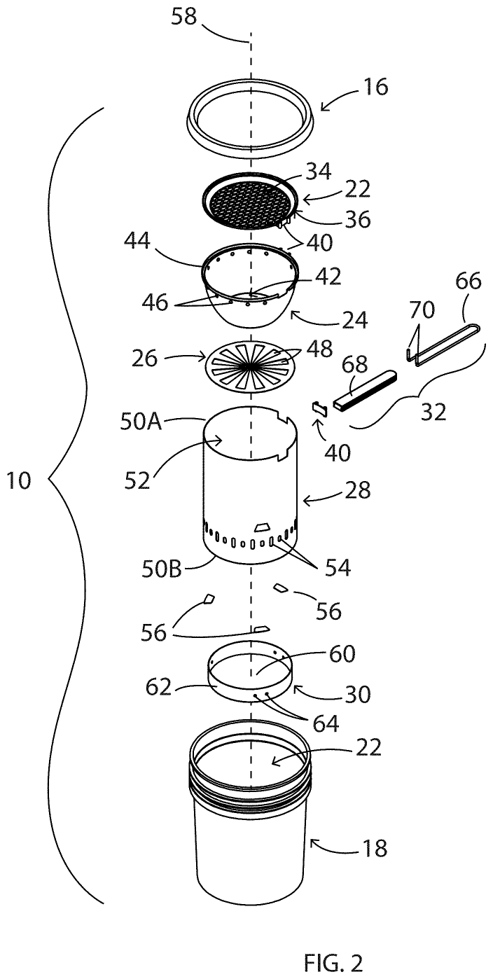

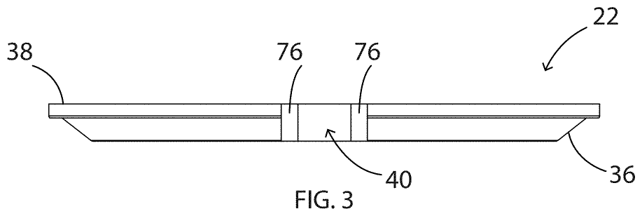

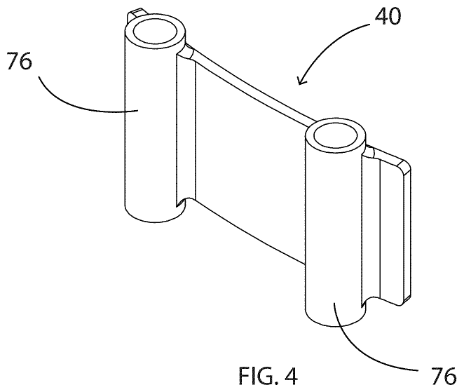

Referring now to FIGS. 2-4, the portable cooking system 10 is shown in greater detail. FIG. 2 shows a fully exploded view of the portable cooking system 10 is shown, FIG. 3 shows a cross-sectional view of a cooking platform, and FIG. 4 shows a perspective view of a handle engagement element.

Referring to FIG. 2, the lid 16 and receptacle 18 are as shown and described in FIG. 1. As is shown in FIG. 2, in some embodiments the cooking unit 14 generally includes a cooking platform 22, a basin/lid element 24, a fuel tray 26, a cooking column 28, an ash tray 30, and a handle 32.

Continuing to refer to FIG. 2, in one embodiment the cooking platform 22 is removably engageable with the cooking column 28. In one embodiment, the cooking platform 22 includes a grill surface 34 and a rim 36 at least partially surrounding the grill surface 34. For example, in one embodiment the rim 36 extends around at least a portion of the circumference or outer edge of the grill surface 34. In one embodiment, the grill surface 34 is planar or at least substantially planar and includes one or more apertures. In some embodiments, the grill surface 34 is or includes a grid, mesh, woven surface, panel with one or more apertures, or other configuration that allows air and smoke to pass therethrough. Alternatively, in some embodiments the grill surface 34 defines a solid surface, such as a griddle surface or continuous panel, that is impermeable to air and/or smoke. For example, although a grill-style cooking platform 22 is shown in the figures, it will be understood that surfaces other than that shown may be used, such as a flat griddle-type, mesh, skewer, rotisserie, or other cooking surface or device. The grill surface 34 includes a first surface and a second surface opposite the first surface, and either may be used to cook and/or prepare food. In some embodiments, the grill surface 34 is planar or at least substantially planar. The grill surface 34 is composed of a thermally conductive and food-safe material such as metal (for example, stainless steel or cast iron).

Continuing to refer to FIG. 2, and with reference to FIG. 3, in one embodiment the rim 36 extends radially outward from, and coplanar or at least substantially coplanar with, the grill surface 34. In other embodiments, the rim 36 extends away from the first surface of the grill surface 34, at an angle from the plane in which the grill surface 34 lies. For example, the rim 36 may extend from the plane of the grill surface 34 at an angle of between approximately 10° to approximately 90° (±5°). Put another way, in some embodiments, the rim 36 is tapered from an upper edge 38 of the rim 36 toward the first surface of the grill surface 34 (for example, as shown in FIG. 3). In one embodiment, the grill surface 34 has an outer diameter that is at least slightly less than an outer diameter of the cooking column 28 and at least a portion of the rim 36 has an outer diameter that is at least slightly greater than the than an outer diameter of the cooking column 28. Thus, the cooking platform 22 may rest on the cooking column 28, without falling in, because of the larger outer diameter of at least a portion of the rim 36. In one non-limiting example, the rim 36 has a radius of approximately 4.7 inches (±0.5 inch). Further, in some embodiments the rim 36 includes a handle engagement element 40 that is sized and configured to accept at least a portion of the handle 32, as discussed in greater detail below.

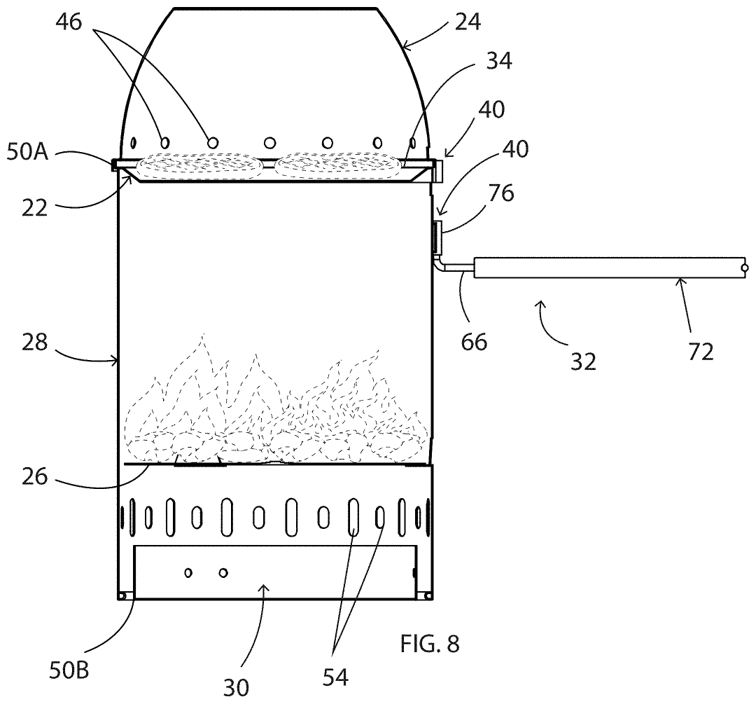

Continuing to refer to FIG. 2, and with reference to FIGS. 5 and 8, in one embodiment the basin/lid element 24 is a domed or curved lid that is sized and configured for use as either a lid (for example, when in a convex first orientation, as shown in FIG. 5) and/or a liquid basin (for example, when in a concave second orientation, as shown in FIG. 8). In one embodiment, the basin/lid element 24 has a flattened surface 42 and a rim 44 opposite the flattened surface 42. In one non-limiting example, the flattened surface 42 of the basin/lid element 24 has a diameter of approximately 6.0 inches (±0.5 inch) and the rim 44 has a diameter of approximately 9.5 inches (±0.5 inch). However, it will be understood that the basin/lid element 24 may have other suitable sizes and/or configurations. In some embodiments, the basin/lid element 24 further includes one or more apertures 46 to allow an amount of air to flow through the basin/lid element 24. In one embodiment, the basin/lid element 24 includes a plurality of apertures 46 proximate and around the rim 44. In one embodiment, the basin/lid element 24 includes a handle engagement element 40 that is sized and configured to accept at least a portion of the handle 32, as discussed in greater detail below. In one embodiment, the handle engagement element 40 has the same or substantially the same configuration as that of the cooking platform 22. In one embodiment, the handle engagement element 40 is located proximate the rim 44 of the basin/lid element 24.

Continuing to refer to FIG. 2, in some embodiments the basin/lid element 24 is sized and configured to be used over the cooking platform 22 when the cooking unit 14 is in use, such as when the basin/lid element 24 is in the convex first orientation. In one embodiment, at least a portion of the rim 44 has a diameter that is at least slightly less than a diameter (for example, an outer diameter) of the grill surface 34, so the basin/lid element 24 may rest atop and be supported by the cooking platform 22 when the basin/lid element 24 is in the convex first orientation. For example, the basin/lid element 24 may be used to capture heat, steam, and/or smoke to decrease cooking time, cook thicker cuts of meat, etc. In some embodiments, the basin/lid element 24 is further sized and configured to be used beneath the cooking platform 22, at least partially within the cooking column 28, when the cooking unit 14 is in use, such as when the basin/lid element 24 is in the concave second orientation. In one embodiment, at least a portion of the rim 44 has a diameter that is at least slightly greater than a diameter (for example, an inner diameter) of the cooking column 28, so the basin/lid element 24 may be suspended at least partially within the cooking column 28 when the basin/lid element 24 is in the concave second orientation. For example, the basin/lid element 24 may be used to retain an amount of fluid or liquid, such as water or broth, to steam and/or infuse vegetables, meat, or other food items on the grill surface 34.

Continuing to refer to FIG. 2, in one embodiment the fuel tray 26 is a planar, or at least substantially planar disk, and includes at least one aperture 48 to allow air flow therethrough. In one embodiment, the fuel tray is sized and configured to fit within the cooking column 28 and to support a fuel source, such as wood, charcoal, paper, and/or other materials beneath the cooking platform 22 and, in some use configurations, the basin/lid element 24 when the cooking unit 14 is in use. In one embodiment, the fuel tray 26 includes a plurality of triangular or slice-shaped apertures 48 extending radially about a center point. In one embodiment, the fuel tray is composed of a rigid or semi-rigid material that is heat resistant and food safe. In one non-limiting example, the fuel tray 26 has a thickness of approximately 0.1 inch (±0.05 inch) and a diameter of approximately 8.8 inches (±0.5 inch). However, it will be understood that other suitable sizes, shapes, and configurations may be used.

Continuing to refer to FIG. 2, in one embodiment the cooking column 28 is a tubular (or cylindrical), or at least substantially tubular (or cylindrical), structure with an open first end 50A, an open second end 50B, and a chamber 52 extending therebetween. In one embodiment, the cooking column 28 includes at least one handle engagement element 40 proximate the edge of the open first end 50A. In one embodiment, the cooking column 28 includes one or more apertures 54 proximate the edge of the open second end 50B. In one embodiment, the cooking column 28 includes a plurality of apertures 54 extending in a row around the circumference of the open second end 50B. The plurality of apertures 54 may have the same or a variety of sizes, shapes, and configurations. In one embodiment, the cooking column is composed of metal (for example, aluminum, stainless steel, or cast iron) or other suitable non-flammable and food-safe material. In one non-limiting example, the cooking column 28 has a height of approximately 13 inches (±2.0 inches), an outer diameter of approximately 9.2 inches (±0.5 inch), and an inner diameter of approximately 8.7 inches (±0.5 inch).

Continuing to refer to FIG. 2, in one embodiment the cooking column 28 includes a plurality of tabs 56 within the chamber 52 that are sized and configured to support the fuel tray 26. In one embodiment, the cooking column 28 has a longitudinal axis 58 (which is also the same longitudinal axis of the portable cooking system 10, as shown in FIG. 2) and the plurality of tabs 56 extend along a plane that is orthogonal, or at least substantially orthogonal, to the longitudinal axis 58. Further, when the cooking unit 14 is assembled and the fuel tray 26 is resting on the plurality of tabs 56, at least the grill surface 34 and the fuel tray 26 are parallel. In one embodiment, the plurality of tabs 56 are coupled to an inner surface of the cooking column 28, such as by welding, soldering, chemical bonding, adhesive bonding, thermal bonding, or the like. In another embodiment, the plurality of tabs 56 are formed by punching through the body of the cooking column 28 and bending the material into the chamber 52 to form the plurality of tabs 56. It will be understood that the plurality of tabs 56 may have other sizes, shapes, configurations, and/or number that are suitable to support the fuel tray 26 within the cooking column 28.

Continuing to refer to FIG. 2, the ash tray 30 is a plate, tray, basin, or other receptacle that is sized and configured to protect a surface on which the cooking unit 14 is placed (support surface) from ash, food debris, heat, and/or other materials that may be produced or may fall from other elements of the cooking unit 14 when the cooking unit is in use. In one embodiment, the ash tray 30 includes a planar, or at least substantially planar, bottom surface 60 and a rim 62 extending upward from and around the circumference of the bottom surface 60. In one embodiment, the ash tray 30 further includes one or more apertures 64 to allow air flow therethrough. In one non-limiting example, the ash tray 30 has a diameter of approximately 8.2 inches (±0.5 inch). In one embodiment, the ash tray 30 is composed of a rigid or semi-rigid material, such as metal. In one embodiment, the ash tray 30 is composed of a material that does not easily conduct heat to a support surface on which it rests and/or that thermally shields the support surface from heat from the cooking unit 14. In one embodiment, the ash tray 30 includes a handle engagement element 40, such as on the rim 62.

Continuing to refer to FIG. 2, in one embodiment the handle 32 broadly includes a graspable portion and an engagement portion that is removably couplable to a handle engagement element 40. In one embodiment, the handle 32 generally includes a frame 66 and an insert 68. In one embodiment, the frame 66 is elongated piece of rigid material, such as metal, that is bent back on itself such that opposing free ends 70 are proximate each other and opposite the bend. Further, in this embodiment the opposing free ends 70 are bent at an angle of approximately 90° (±10°) from the remainder of the frame 66, thereby giving the frame 66 has an L-shape that includes an elongated first portion 72 extending in a first direction and a shorter second portion 74 extending in a second direction that is different than (for example, oriented approximately 90° from) the first direction (for example, as shown in FIG. 5). In one embodiment, the insert 68 is composed of a rigid or semi-rigid material and is sized and shaped to fit within and be retained by the elongated portion of the frame 66. In one embodiment, the insert 68 includes a groove extending along at least a portion of the sides of the insert 68, which groove is sized and configured to accept at least a portion of the frame 66. In one embodiment, the insert 68 is composed of wood, although other materials may be used. Further, in some embodiments the frame 66 and/or the insert 68 are composed of a heat-resistant material to prevent burns or injury when the handle 32 is grasped by the user. However, it will be understood that the handle 32 may have any suitable size, shape, and/or configuration that allows it to be usable by a user as a handle to move a component of the cooking unit 14.

Continuing to refer to FIG. 2, and with reference to FIG. 4, in one embodiment the handle engagement element 40, regardless of location in the cooking unit 14, generally includes at least one tubular element 76 that is sized and configured to receive one of the opposing free ends 70 of the frame 66 of the handle 32. In one embodiment, the handle engagement element 40 includes two tubular elements 76, one for receiving a first opposing free end 70 and one for receiving a second opposing free end 70. In some embodiments, the handle engagement element 40 includes a plate or backing that is contoured to match the curvature of the component to which it is attached. In other embodiments, the handle engagement element 40 is attached to or integrated with the component to which it is attached, such as by affixing or integrating the tubular elements 76 directly with the component (without a plate or backing). In one embodiment, the handle engagement element 40 is manufactured as a separate piece and coupled to the cooking column 28, such as on an outer surface or within a notch or cutout in the cooking column 28, by welding, soldering, chemical bonding, adhesive bonding, thermal bonding, or the like. In other embodiments, the handle engagement element is integrated with or formed as a single piece with the cooking column 28.

Continuing to refer to FIG. 2, in one exemplary method of use, the engagement portion of the handle 32 (such as the opposing free ends 70) is inserted or otherwise engaged with the handle engagement element 40 in such a way that allows a user to lift and move the corresponding component of the cooking unit 14. In one embodiment, the opposing free ends 70 are inserted upward through the tubular elements 76 of the handle engagement element 40 to support the corresponding component of the cooking unit 14. Similarly, the engagement portion (such as the opposing free ends 70) is easily removable or disengageable from the handle engagement element 40, for example, by lowering the opposing free ends 70 downward and out of the tubular elements 76. Thus, a user may quickly and easily engage the handle 32 with, and disengage the handle 32 from, a component of the cooking unit 14 that includes a handle engagement element 40. For example, to move the cooking platform 22, a user may insert the opposing free ends 70 of the handle 32 upward through the tubular elements 76 of the handle engagement element 40, and the weight of the cooking platform 22 is at least partially supported by the elongated first portion 72 of the handle 32. After moving the cooking platform 22 to a desired location, the user may then lower the opposing first ends 70 out of the tubular elements 76 of the handle engagement element 40. If desired, the user may then engage the handle 32 with a handle engagement element 40 of another component of the cooking unit 14, such as the basin/lid element 24, the cooking column 28, the ash tray 30, or other component having a handle engagement element 40. However, it will be understood that the handle 32 and/or the handle engagement element 40 may have other suitable sizes, shapes, and/or configurations. In one non-limiting example, the handle engagement element 40 may include a single tubular element 76 and the handle 32 may likewise include a single free end 70. Additionally, the handle 32 may engage the handle engagement element 40 in other ways, such as by insertion of the opposing free ends 70 downward through the tubular elements 76 of the handle engagement element 40.

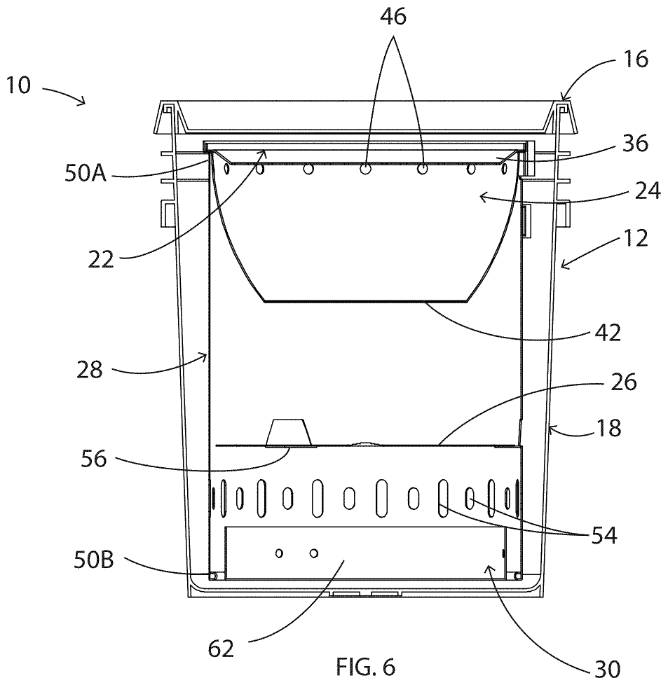

Referring now to FIGS. 5 and 6, the portable cooking system 10 is shown in a storage configuration. FIG. 5 shows a perspective view and FIG. 6 shows a cross-sectional view of the portable cooking system 10 in the storage configuration.

Continuing to refer to FIGS. 5 and 6, as discussed above, the cooking unit 14 is sized and configured to fit within the outer container 12. In one embodiment, the outer container is a five-gallon bucket, but other suitable types, sizes, shapes, and configurations of containers may be used.

Continuing to refer to FIGS. 5 and 6, in one embodiment the cooking unit 14 fits entirely within the chamber 20 of the outer container 12, including when the lid 16 is coupled to the receptacle 18. In one embodiment, the cooking unit 14 is stored with the cooking column 28 standing upright within the chamber 20, with the ash tray 30 at the bottom (that is, proximate the open second end 50B) and the cooking platform 22 and the basin/lid element 24 at the top (that is, proximate the open first end 50A). Although not shown, the handle 32 and/or other items may be placed within the chamber 52 of the cooking column 28 and/or between the cooking column 28 and the inner surface of the receptacle 18 of the outer container 12. However, other suitable configurations for storing the cooking unit 14 and/or additional items may be used.

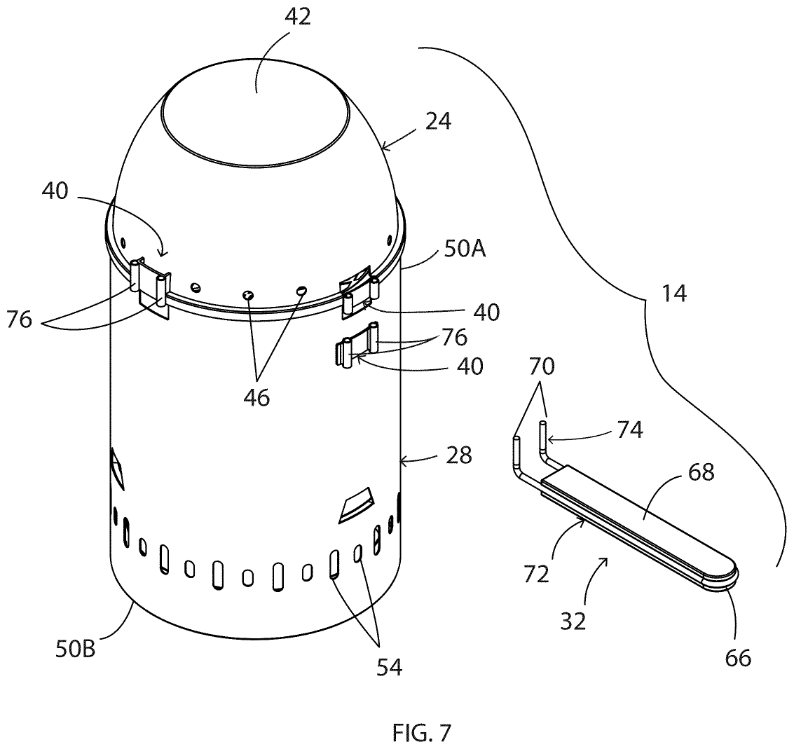

Referring now to FIGS. 7 and 8, the portable cooking system 10 is shown in a use configuration. FIG. 7 shows a perspective view and FIG. 8 shows a cross-sectional view of the portable cooking system 10 in the use configuration.

Continuing to refer to FIGS. 7 and 8, in one embodiment the basin/lid element 24 is used in the convex first orientation. In this orientation, the basin/lid element 24 is supported by the cooking platform 22, with the rim 44 being in contact with at least a portion of the cooking platform 22. For example, in one embodiment the rim 44 is in contact with at least a portion of the inner surface of the rim 36 of the cooking platform 22. In the use configuration, the fuel tray 26 supports a fuel source and flame beneath the cooking platform 22, and above the ash tray 30. Further, as shown in FIG. 7, the handle engagement element 40 of each of the cooking platform 22, basin/lid element 24, and cooking column 28 are exposed and freely engageable with the handle 32. For example, if the user wants to check food items cooking on the grill surface 34, the user may engage the handle 32 with the handle engagement element 40 of the basin/lid element 24 and use the handle 32 to lift the basin/lid element 24 away from the cooking platform 22.

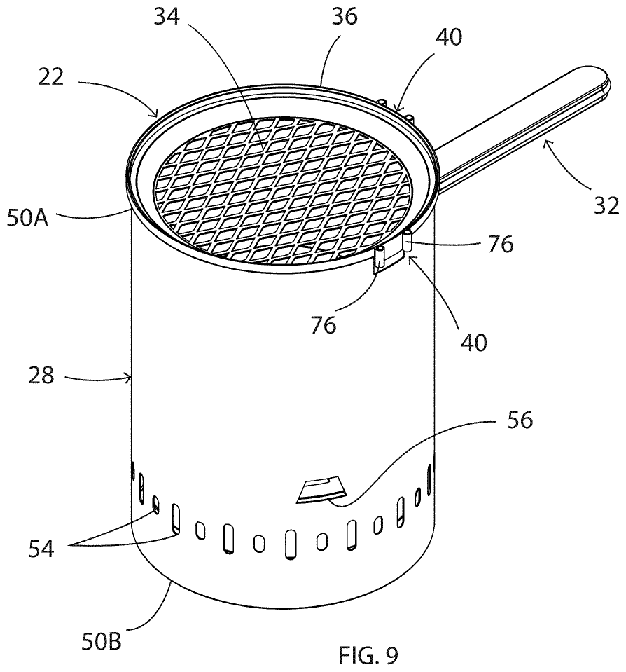

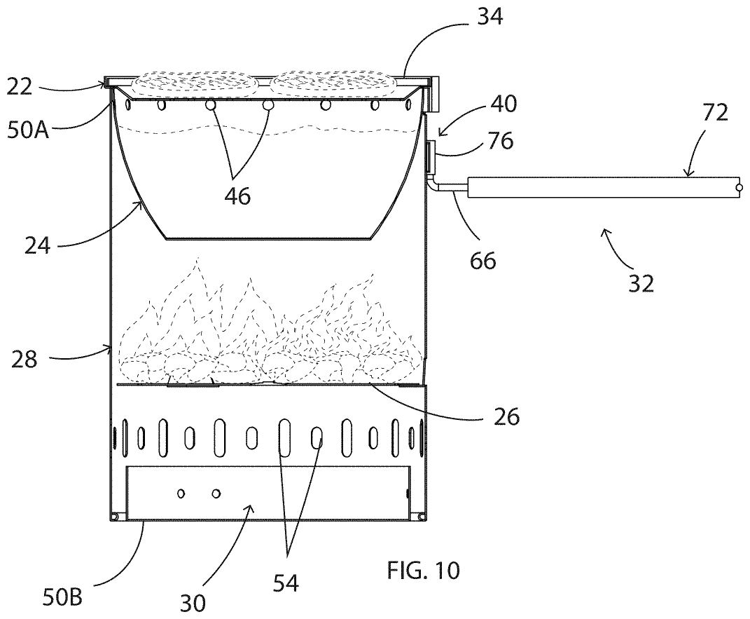

Referring now to FIGS. 9 and 10, the portable cooking system 10 is shown in an alternative use configuration. FIG. 9 shows a perspective view and FIG. 10 shows a cross-sectional view of the portable cooking system 10 in the alternative use configuration.

Continuing to refer to FIGS. 9 and 10, in one embodiment the basin/lid element 24 is used in the concave second orientation. In this orientation, the basin/lid element 24 is supported by the open first end 50A of the cooking column 28, with the rim 44 being in contact with at least a portion of each of the open first end 50A and the cooking platform 22. For example, in one embodiment the rim 44 is sandwiched between an outer surface of the rim 36 of the cooking platform 22 and the edge of the open first end 50A of the cooking column 28. In the use configuration, the fuel tray 26 supports a fuel source and flame above the ash tray 30 and beneath the basin/lid element 24, which is, in turn, beneath the cooking platform 22. Further, as shown in FIG. 7, the handle engagement element 40 of each of the cooking platform 22, basin/lid element 24, and cooking column 28 are exposed and freely engageable with the handle 32. For example, if the user wants to remove the cooking platform 22 from the cooking unit 14, the user may engage the handle 32 with the handle engagement element 40 of the of the cooking platform 22 and then use the handle 32 to lift the cooking platform 22 away from the cooking column 28.

Additionally, it will be understood that the cooking unit 14 may be used and/or stored in configurations other than those shown and described herein. For example, the cooking unit 14 may be used to cook food without using the basin/lid element 24 and/or the ash tray 30, and/or a fuel source may be placed in/on the ash tray 30 or directly on the surface on which the cooking column 28 rests, without using the fuel tray 26.

In one non-limiting example of use, the user removes the cooking unit 14 from the outer container 12 and places the cooking unit 14 on the ground, on a table, on a tailgate, or on other support surface. Optionally, if the support surface is flammable or could be damaged by heat, a heat-resistant layer may be used between the support surface and the cooking unit 14. For example, tin foil or other material may be used to thermally insulate the cooking unit 14 from the support surface. Additionally or alternatively, as discussed above, the ash tray 30 may be used to not only contain ash and other debris, but in some embodiments may also be used to thermally shield the support surface from heat. Once the cooking unit 14 has been removed from the outer container 12 and placed on the support surface with the open second end 50B in contact with the support surface, an amount of charcoal, wood, paper, tinder, or other fuel may be placed inside the cooking column 28, such as on the fuel tray 26, and ignited. The user may then place the cooking platform 22 on the open first end 50A of the cooking column 28 and, optionally, place food item(s) on the cooking platform 22.

In one embodiment, after use the user removes the cooking column 28 from the support surface and leaves behind the fuel and/or fuel remnants, such as embers, charcoal, ash, or the like. Alternatively, if the ash tray 30 is used, the user may then empty the ash tray 30 before storing the cooking unit 14 within the outer container 12. Therefore, in one embodiment the fuel and/or fuel remnants, which is typically messy, is left for cleanup and does not remain in the portable cooking system 10, thereby keeping the outer container 12 and cooking unit 14 cleaner and more easily transported and stored. In one embodiment, the cooking column 28 may be allowed to cool completely before or after removing it from the support surface, or at least to cool to a temperature that is cool to the touch (for example, room temperature or slightly above) so it can be safely handled by the user. Once cool, the cooking column 28, cooking platform 22, fuel tray 26, ash tray 30, and other items or components may then be placed inside the chamber 20 of the outer container 12 and sealed by coupling the lid 16 to the receptacle 18. Additionally, if desired, the ash tray 30 and/or any other food debris or other waste or debris may be packed into the outer container 12 with the cooking unit 14, where it all will be securely contained. Thus, all components of the portable cooking system 10 are contained within the outer container 12 for easy transport and/or storage. In some embodiments, the portable cooking system 10 include a frame, insert, or other device to stabilize components and/or items within the outer container 12 and to prevent rattling and damage, and/or to keep the components and/or items organized and easily accessible. In one embodiment, the portable cooking system 10 includes padding sized and configured to be placed around at least a portion of the inner circumference of the chamber 20 and/or between components.

### Embodiments

In one embodiment, a portable cooking system comprises: an outer container defining a chamber; and a portable cooking apparatus being configured to be entirely contained within the chamber of the outer container, the portable cooking apparatus including: a cooking column; and a cooking surface.

In one aspect of the embodiment, the portable cooking system further comprises a lid, the lid being removably attachable to the outer container.

In one aspect of the embodiment, the cooking surface is at least substantially planar. In one aspect of the embodiment, the cooking surface includes a plurality of apertures.

In one aspect of the embodiment, the cooking column and the cooking surface are removably engageable with each other.

In one aspect of the embodiment, the cooking column has an at least substantially cylindrical shape, the cooking column including an open first end and an open second end opposite the open first end.

In one aspect of the embodiment, the cooking column further includes a plurality of apertures proximate the open second end.

In one aspect of the embodiment, the portable cooking apparatus further includes a domed cooking lid.

In one aspect of the embodiment, the domed cooking lid includes a dome that extends away from the cooking surface when the portable cooking apparatus is in a use configuration and that extends within the cooking column when the portable cooking apparatus is in a storage configuration.

In one aspect of the embodiment, domed cooking lid includes a vent.

In one aspect of the embodiment, the domed cooking lid includes a dome portion and a ring extending from the domed portion. In one aspect of the embodiment, the portable cooking system further comprises a lid hook, the lid hook including a hook portion configured to engage with the ring. In one aspect of the embodiment, the lid hook includes: a handle portion extending along a first longitudinal axis; and a hook portion having a linear portion and a hook, the linear portion extending along a second longitudinal axis that is at least substantially orthogonal to the first longitudinal axis.

In one aspect of the embodiment, the portable cooking apparatus further comprises a rotisserie apparatus. In one aspect of the embodiment, the rotisserie apparatus includes at least one piercing element, at least a portion of the at least one piercing element being engageable with the cooking column.

In one embodiment, a portable cooking system comprises: a cooking column including an open first end and an open second end opposite the open first end, the open first end having an inner diameter; a domed lid having an edge, the edge having a diameter; and a cooking surface pan including: an at least substantially planar cooking surface having a first surface and a second surface opposite the first surface; and a tapered lip surrounding the cooking surface and extending from the first surface of the cooking surface, the tapered lip having a free edge, a first diameter at a location where the tapered lip meets the first surface of the cooking surface, and a second diameter at the free edge, wherein: the first diameter of the tapered lip is less than the inner diameter of the cooking column; the second diameter of the tapered lip is greater than the inner diameter of the cooking column; and the diameter of the edge of the domed lid is greater than the second diameter of the tapered lip.

In one embodiment, a method of using a portable cooking system comprises: disengaging a lid from an outer container, the outer container defining a chamber therein; removing a portable cooking apparatus from the outer container, the portable cooking apparatus including: a cooking column, the cooking column having an open first end, an open second end opposite the open first end, and a chamber extending therebetween; and a cooking surface; placing the cooking column on a support surface such that the open second end of the cooking column is in contact with the support surface; and placing the cooking surface on the open first end of the cooking column.

In one aspect of the embodiment, the method further comprises: before placing the cooking surface on the open first end of the cooking column, placing a fuel in the chamber of the cooking column and igniting the fuel. In one aspect of the embodiment, the method further comprises: allowing the cooking column and cooking surface to cool; either before or after allowing the cooking column and cooking surface to cool, removing the cooking surface from the cooking column; removing the cooking column from the support surface, leaving the fuel on the support surface; placing the cooking column and the cooking surface into the chamber of the outer container; and re-engaging the lid with the outer container.

In one aspect of the embodiment, the method further comprises: placing a domed cooking lid over the cooking surface.

It should be understood that various aspects disclosed herein may be combined in different combinations than the combinations specifically presented int eh description and the accompanying drawings. It should also be understood that, depending on the example, certain acts or events of any of the processes or methods described herein may be performed in a different sequence, may be added, merged, or left out altogether (e.g., all described acts or events may not be necessary to carry out the techniques).

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A portable cooking system comprising:
an outer container defining a chamber; and
a cooking unit being configured to be entirely contained within the chamber of the outer container, the cooking unit being removable from the outer container.

2. The portable cooking system of claim 1, wherein the outer container includes a receptacle and a lid, the lid being removably couplable to the outer container.

3. The portable cooking system of claim 1, wherein the cooking unit includes:
a cooking column; and
a cooking platform, the cooking platform being removably engageable with the cooking column.

4. The portable cooking system of claim 3, wherein:
the cooking column has a longitudinal axis; and
the cooking platform is at least substantially planar, the cooking platform lying in a plane that is at least substantially orthogonal to the longitudinal axis of the cooking column.

5. The portable cooking system of claim 3, wherein the cooking column has an at least substantially cylindrical shape with an open first end and an open second end opposite the open first end, the cooking platform being removably engageable with the open first end.

6. The portable cooking system of claim 5, wherein the cooking column includes a plurality of apertures proximate the open second end.

7. The portable cooking system of claim 5, wherein the open second end is configured to rest on a support surface when the cooking unit is in a use configuration.

8. The portable cooking system of claim 3, wherein the cooking unit further includes:
a fuel tray; and
a plurality of tabs extending from an inner surface of the cooking column, the plurality of tabs being configured to support the fuel tray within the cooking column and beneath the cooking platform when the cooking unit is in a use configuration.

9. The portable cooking system of claim 8, wherein the cooking unit further includes an ash tray, the ash tray being configured to be beneath the cooking platform and the fuel tray when the cooking unit is in the use configuration.

10. The portable cooking system of claim 8, wherein the fuel tray is at least substantially planar and includes a plurality of apertures.

11. The portable cooking system of claim 3, wherein the cooking unit further includes a basin/lid element, the basin/lid element being securely positionable on the cooking platform in a first use configuration and being securely positionable within the cooking column in a second use configuration.

12. The portable cooking system of claim 11, wherein the basin/lid element has a convex first orientation when in the first use configuration and a concave second orientation when in the second use configuration.

13. The portable cooking system of claim 11, wherein the cooking unit further includes a handle, each of the cooking column, the cooking platform, and the basin/lid element including at least one handle engagement element, and the handle being removably engageable with each of the at least one handle engagement element.

14. The portable cooking system of claim 13, wherein:
each of the at least one handle engagement element includes a first tubular element and a second tubular element; and
the handle includes a first free end and a second free end, the first free end being configured to be inserted into the first tubular element and the second free end being configured to be inserted into the second tubular element.

15. The portable cooking system of claim 14, wherein the handle further includes a frame and an insert, the frame defining the first free end and the second free end, and the insert being configured to be retained within the frame.

16. The portable cooking system of claim 1, wherein the cooking unit includes a handle, the handle being removably engageable with at least a portion of the cooking unit.

17. A portable cooking system comprising:
an outer container, the outer container defining a chamber; and
a cooking unit, the cooking unit including:
a cooking column, the cooking column having an open first end and an open second end;
a cooking platform, the cooking platform being engageable with the open first end of the cooking column;
a fuel tray, the fuel tray being configured to be suspended within the cooking column; and
a basin/lid element, the basin/lid element being configured to rest on the cooking platform in a first use configuration of the cooking unit and being configured to be suspended within the cooking column in a second use configuration of the cooking unit,
the cooking unit being external to the outer container in the first and second use configurations of the cooking unit; and
the cooking unit being entirely contained within the chamber of the outer container in a storage configuration of the cooking unit.

18. The portable cooking system of claim 17, wherein the cooking unit further includes a handle, each of the cooking column, the cooking platform, and the basin/lid element including at least one handle engagement element, and the handle being removably engageable with each of the at least one handle engagement element.

19. A method of using a portable cooking system, the portable cooking system including an outer container and a cooking unit, the method comprising:
removing the cooking unit from the outer container, the cooking unit including:
a cooking column, the cooking column having an open first end, an open second end opposite the open first end, and a chamber extending therebetween; and
a cooking platform;
placing the cooking column on a support surface such that the open second end of the cooking column is in contact with the support surface; and
placing the cooking platform on the open first end of the cooking column.

20. The method of using a portable cooking system of claim 19, the method further comprising:
removing the cooking platform from the cooking column;
removing the cooking column from the support surface;
placing the cooking column and the cooking platform into the outer container; and
sealing the outer container.
